(19) United States
(12) Patent Application Publication
(10) Pub. No.: US 2019/0387880 A1
(43) Pub. Date: Dec. 26, 2019

(54) LILO (Lock-in/Lock-out) box

(71) Applicant: Nathan Farmer, Cumming, GA (US)

(72) Inventor: Nathan Farmer, Cumming, GA (US)

(21) Appl. No.: 16/016,547

(22) Filed: Jun. 23, 2018

(51) Int. Cl. A47B 88/457; E05F 15/652; E05G 1/026

(52) U.S. Cl. CPC A47B 88/457; E05B 65/46; E05G 1/026; E05F 15/652

(57) ABSTRACT

A device that can store many different items. However, the major part of this device is that it operates solely by wireless remote. There is an optional switch that can be implemented in case the wireless remote has the potential to be lost. It protects the items within from others and it has the option of being powered by a rechargeable battery.

### FIELD

The present application relates to storing items into a secure unit that can only be opened and closed by a wireless remote unless requested to also include a button to open and close the unit.

### BACKGROUND

People in general usually have things they hold dear to their heart whether its documents, music equipment, dishware, shoes, guns and/or jewelry to name a few. Other individuals may have a challenging time keeping their homes clean from all the items kids throw on the floor; therefore, keeping company from coming over. Individuals may have guest over and there is always those several individuals who drinks all the alcoholic beverages without bringing anything. Being able to control these instances starts with having a device that can store all your things and keep individuals out.

### SUMMARY

By providing this device, not only does it allow one to easily clean their environment in minutes by storing all their belongings into LILO and locking it away at the click of a wireless remote, but also can be used as decor in a room, disguising what it is.

### BRIEF DESCRIPTION OF THE DRAWINGS

FIG. 1 is the front view of LILO.

FIG. 2 is the side view of LILO.

FIG. 3 is the back view of LILO.

FIG. 4 is the front view of LILO II.

FIG. 5 is the side view of LILO II.

FIG. 6 is the back view of LILO II.

### DETAILED DESCRIPTION

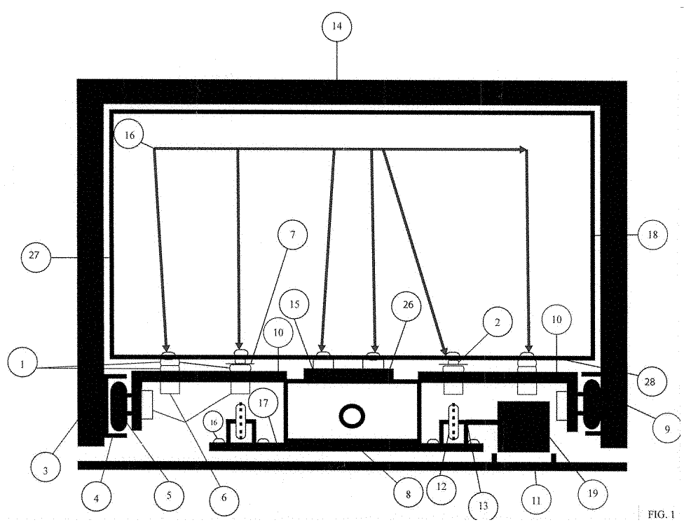

The LILO & LILO II displayed in FIG. 1 through FIG. 6 can be made with different materials and various sizes. The elements that allows the drawer to move has several options to choose from to achieve the same outcome. The sliding mechanism 8 is connected to a servomotor and lead screw. By the servomotor 8 being connected to the circuit card located in 20 and/or 21 a wireless remote 25 can open and close the unit with ease by pressing either “A” button. The letter “A” only a symbol for a button and not an actual letter on the wireless remote.

In FIG. 1 the LILO can be administered in another way by connecting the servomotor 19 to the gears 12 and gear support bracket 13 which attaches to the left and right support bracket 10 that is connected to the bottom drawer panel 28 via gear chain 7, washers 1 & 2, and screws 16. The servomotor 19 is also attached to the circuit card 20 and/or 21 which allows the wireless remote 25 to activate the servomotor 19 to move the gears 12 allowing the drawer to open and close.

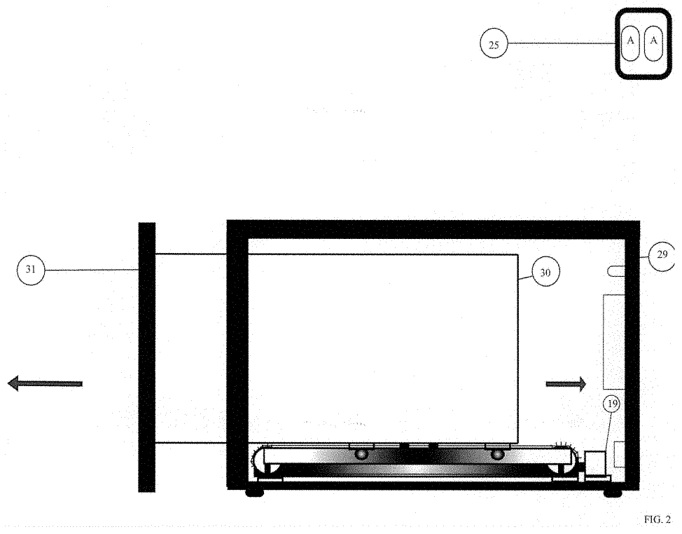

FIG. 2 shows the actual movement of the LILO when the wireless remote 25 is pressed to open and close the drawer.

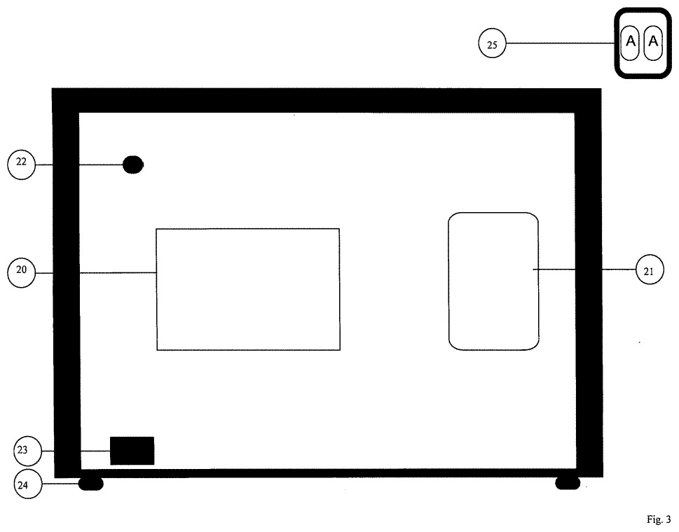

FIG. 3 shows the back view of LILO which consists of the “optional” open/close button (switch). This can be used in case the wireless remote 25 cannot be located. The location of the circuit card enclosure with a tracker slot and battery enclosure 20 and/or 21. The battery enclosure is for a rechargeable battery to replace having a power adapter connection 23. 24 are the legs displayed at the bottom of the unit to raise LILO to stop the drawer from getting caught on carpet or elevated surfaces.

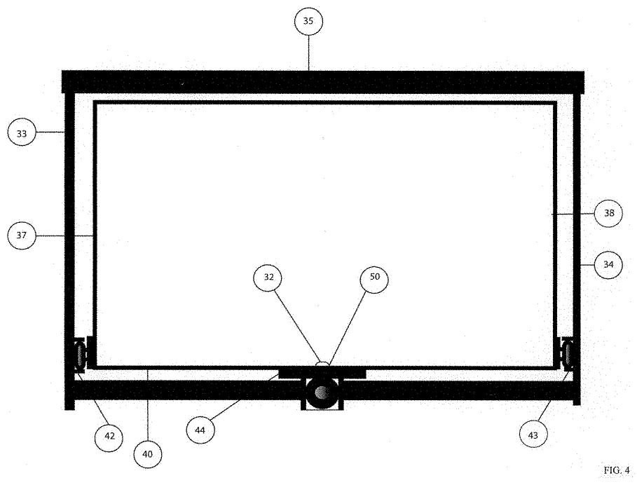

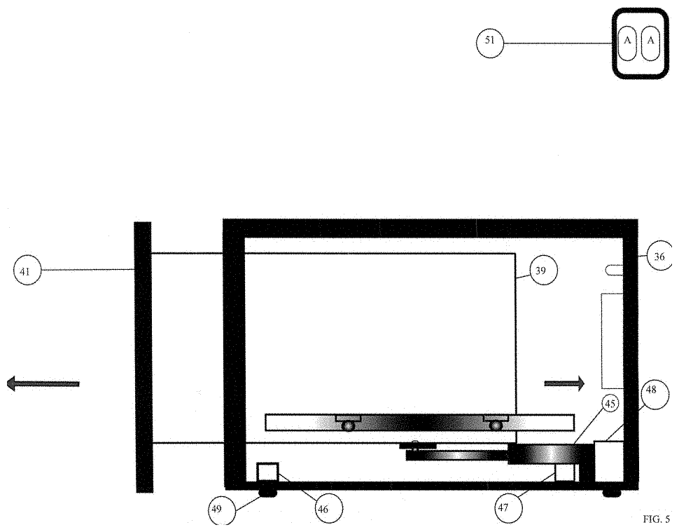

FIG. 4 shows the drawer on left and right sliding track connected to a linear actuator 45 that is held in place by a guard 47. FIG. 5 shows the movement of the drawer once the linear actuator 45 is activated through the circuitry card of the wireless remote 51.

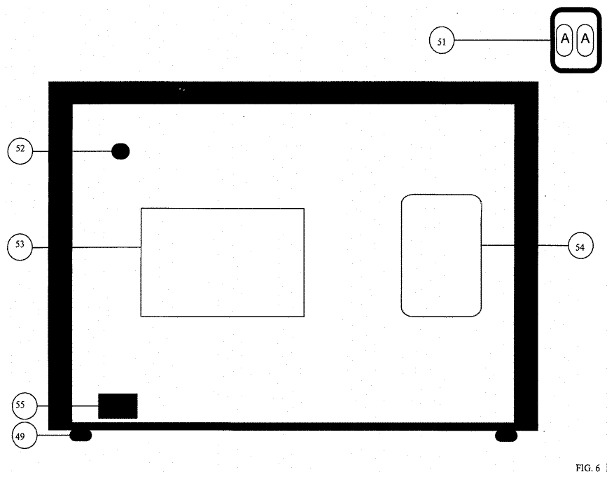

FIG. 6 shows the back view of LILO II which consists of the “optional” open/close button (switch) 51. This can be used in case the wireless remote 51 cannot be located. The location of the circuit card enclosure with a tracker slot and battery enclosure 53 and/or 54. The battery enclosure is for a rechargeable battery to replace having a power adapter connection 55. 49 are the legs displayed at the bottom of the unit to raise LILO to stop the drawer from getting caught on carpet or elevated surfaces.

### BACKGROUND OF INVENTION

I created this invention as a Capstone project for my Associates Degree in Engineering from ITT Technical Institute. Instead of creating works designed for students to build, I wanted to test the knowledge I obtained. As a music producer I have devices and gear I′m either not using or have no place to store or worrying if these things would get stolen so, I wanted to create a device that not only stores whatever I want, but is also portable while keeping the items within the device safe from prying eyes. This is when I decided to add a wireless remote to the device so no-one can get in the device; which means it cannot not be opened or closed without the remote unless a “lock-in/lock-out button” (switch) is implemented into the unit; henceforth, receiving the name, LILO (Lock-In/Lock-Out). Due this device can be made in different shapes and sizes I then thought of other applications this can be applied to and certain embodiments of the present invention include but are not limited to totes, crates, couches, ottoman, refrigeration unit, jewelry box, beds, desks, cigar box, in-table, center table, chest, children toy totes, table gun compartments, and more. I built the prototype by myself in my garage only to find the linear actuator is a little noisy. Of course, this was ok with me; however, if I was to sale this product to an individual the noise would probably be the main issue besides the speed when the drawer opens and closes which brought me to design a faster and less noisy box which you will see in the drawings provided here in. I was also approached about building smaller versions of the invention which means the linear actuator that accompanied the first build was to bulky for a smaller unit. I found that a servomotor connected to a threaded sliding mount could achieve the same findings presented by the linear actuator; therefore, creating a new prototype which certain embodiments of the present invention include but are not limited to totes, crates, couches, ottoman, and refrigeration unit, jewelry box, beds, desks, cigar box, in-table, center table, chest, table, music production cases, workstations and more can and will be redesigned. The box also can hold a tracking device within the unit.

To conclude, these inventions aren't just storage capsules of sorts with long-range frequency wireless remotes, and a concealed compartment to host a tracking device. Yes, they store our possessions, but even for children this invention can be used to keep their room or play area clean and/or be used as a way of correcting. Example, if they are not behaving, some thing goes in the box. Either way, it is not only just a choice, but can also become a way of life for the masses. The only question is how would you use it if one were in your possession?

Building the L.I.L.O. BOX I (FIG. 1)
1) Depending on material used for build, connect, fuse, glue (adhesive), weld, screw, or secure Item 27 to Item 31, and Item 30. Then Item 18 to Item 31, and 30.
2) Connect, fuse, glue (adhesive), weld, or screw Item 28 to the bottom of Item 30, Item 27, and Item 18 then fuse, glue, weld or screw to Item 31.
3) Put Item 16 through inside of Item 18. As shown in FIG.1 assemble Item 2, Item 15, Item 1, and Item 7 (optional).
4) Assemble Item 10 and Item 5 then secure it to the components of item 18 with Item 16.
5) (Optional) Assemble Item 7 with Item 12. Then assemble Item 13 with Item 12. Secure Item 13 with Item 16 to Item 17. Secure Item 8 to Item 17 and then secure Item 17 to Item 11. Assemble Item 24 to Item 11.
6) Move Item 8's sliding block to the appropriate position for accurate drawer movement. (Optional) Apply Item 26 to Item 8's mounting block.
7) Assemble drawer to completed step 6 using Item 15 as shown in FIG. 1.
8) Program Item 19 and connect to Item 8.
9) Take the left of Item 4 and assemble to Item 3.
10) Take the right of Item 4 and assemble to Item 9.
11) Install Item 20, 21, 22 and 23 into Item 29.
12) Connect Item 19 to circuit board and remaining electrical circuits/power.
13) Connect Item 24 to Item 11.
14) Take the assembled Item 3 and assemble to Item 5 as shown in FIG. 1 and repeat for Item 9.
15) Connect Item 29 to Item 3, 9, and 11 by fusing, screwing, gluing, welding, or adhesion. Now attach Item 14 by fusing, screwing, gluing, adhesion, or epoxy to complete closure of the unit.
16) Power unit either by battery or AC from outlet.
17) Retrieve Item 25 and press “A” to make the drawer open/close.

### BOM—BILL OF MATERIALS

1) Washers
2) Washers
3) Left Panel
4) Left and Right Rail
5) Wheel
6) Locknuts
7) Gear chain
8) Sliding mechanism
9) Right panel
10) Left and Right support bracket
11) Bottom Panel
12) Gears
13) Gear Support Bracket
14) Top Panel
15) Standoffs
16) Screws
17) Supporting Plate
18) Right Drawer Panel
19) Servomotor
20) (Optional) circuit card enclosure w/tracker slot/battery enclosure
21) (Optional) circuit card enclosure w/tracker slot/battery enclosure
22) (Optional) Open/close button (switch)
23) Power adapter connection
24) Legs
25) Wireless Remote
26) Mounting plate
27) Left drawer panel
28) Bottom Drawer Panel
29) Back Panel
30) Back Drawer Panel
31) Front Drawer Panel
32) Screws
33) Left Panel
34) Right Panel
35) Top Panel
36) Back Panel
37) Left Drawer Panel
38) Right Drawer Panel
39) Back Drawer Panel
40) Bottom Drawer Panel
41) Front Drawer Panel
42) Left Sliding Rack
43) Right Sliding Rack
44) Support Plate
45) Linear Actuator
46) Guard 1
47) Guard 2
48) Guard 3
49) Legs
50) Screw and Locknut
51) Wireless Remote
52) Lock-in/Lock-out switch (optional)
53) Circuit Card Bay and tracker slot
54) DC Battery Enclosure (optional)
55) AC Adapter connection (optional)

Building the LILO BOX II (FIG. 4)

1. A lock box that only opens and closes mainly by a wireless remote by way of linear actuator or with a servomotor/leadscrew/gears and sliding mechanism unless a secondary open/close switch has been implemented.
